(19) United States
(12) Patent Application Publication
(10) Pub. No.: US 2017/0151527 A1
(43) Pub. Date: Jun. 1, 2017

(54) AIR PURIFIER

(71) Applicant: WARD KRAFT, INC., FORT SCOTT, KS (US)

(72) Inventor: JESSE CRUM, FORT SCOTT, KS (US)

(21) Appl. No.: 15/366,822

(22) Filed: Dec. 1, 2016

Related U.S. Application Data
(60) Provisional application No. 62/261,415, filed on Dec. 1, 2015.

(51) Int. Cl. B01D 46/52; B01D 46/00

(52) U.S. Cl. CPC B01D 46/522; B01D 46/523; B01D 46/0024; B01D 46/0045; B01D 2267/30

(57) ABSTRACT

A portable air filtration and purification system with a portable housing having three sides and an open area. The open area facilitates filter replacement. A pre-filter is positioned within the housing. A fan assembly having a fan housing and fan blades is also positioned within the housing and is adjacent the pre-filter. A post-filter is adjacent the fan assembly and is positioned within the housing such that the pre-filer and the post-filter sandwich the fan assembly. The pre-filter intercepts the air flow into the portable air filtration and purification system before the air flows through the fan. The post-filter intercepts the air after it flows through the fan.

### CROSS REFERENCE TO RELATED APPLICATIONS

This application takes priority from U.S. Provisional Patent Application 62/261,415, filed Dec. 1, 2015, the entirety of which is incorporated by reference herein.

### FIELD OF INVENTION

The invention relates in general to portable air filtration and purification units.

### BACKGROUND OF INVENTION

Chronic allergy and asthma sufferers appreciate the need for clean air and understand that many harmful particulates may be suspended in air. Pollen, pet dander, smoke, dust, mold, and viruses are examples of pollutants that cause symptoms of allergies and asthma that are found in air. To combat these and other pollutants companies and individuals in general have been seeking the aid of air filtration devices as stand-alone units or units that attach to HVAC systems. The problem with these units of the past is that, like HVAC, they focus on volume of air movement in cubic feet per minute (cfm), which does not allow the filtration portion of the device to properly or efficiently clean the air going through it. A slower, constant air movement across the filtration portion may significantly increase the efficiency of the device and drastically reduce the number of pollutants to which people are being exposed. There exists a need to develop an air filtration and purification unit that does not focus on volume of air movement but instead focusses on constant air movement and that would clean the air better than prior devices. The unit should be quiet, portable, light weight, and easy to maintain.

### BRIEF SUMMARY OF INVENTION

A stand-alone, portable air filtration and purification unit that requires standard 110V electricity to operate and can easily be moved from room to room in a household, office, or industrial setting. The unit may include a sheet metal shroud which houses an internal fan and two M11 or better filters. One of the filters—a pre-filter—is positioned such that the air enters the pre-filter before the air passes through the fan. The second filter—a post filter—is positioned such that the air passes through the second filter after the air passes through the fan. A dial switch may be used for selecting the fan speed.

### BRIEF DESCRIPTION OF THE DRAWINGS

FIG. 1 is a perspective view of the air filtration and purification unit according to an embodiment.

FIG. 2 is an exploded view of the air filtration and purification unit of FIG. 1.

FIG. 3 is a cross-sectional view of the air filtration and purification unit of the FIG. 1 taken along line 3,4-3,4.

FIG. 4 is a cross-sectional view of the air filtration and purification unit of FIG. 1 showing the path of the air through the unit taken along line 3,4-3,4.

FIG. 5 is a perspective view of the air filtration and purification unit according to a second embodiment.

FIG. 6 is an exploded view of the air filtration and purification unit of FIG. 5.

FIG. 7 is a cross-sectional view of the air filtration and purification unit of FIG. 5 taken along line 7-7.

FIG. 8 is a cross-sectional view of the air filtration and purification unit according to a third embodiment.

### DETAILED DESCRIPTION OF THE INVENTION

Embodiments will now be described in detail with respect to an apparatus and method for assessing skilled professional qualities reflecting the inventors' present preferred embodiments and the best means for practicing the invention. Those skilled in the art will recognize that the embodiments described herein are subject to modification and alteration without departing from the teaching herein. Therefore, the present discussion should not be considered limiting but an exemplification of the features of the invention.

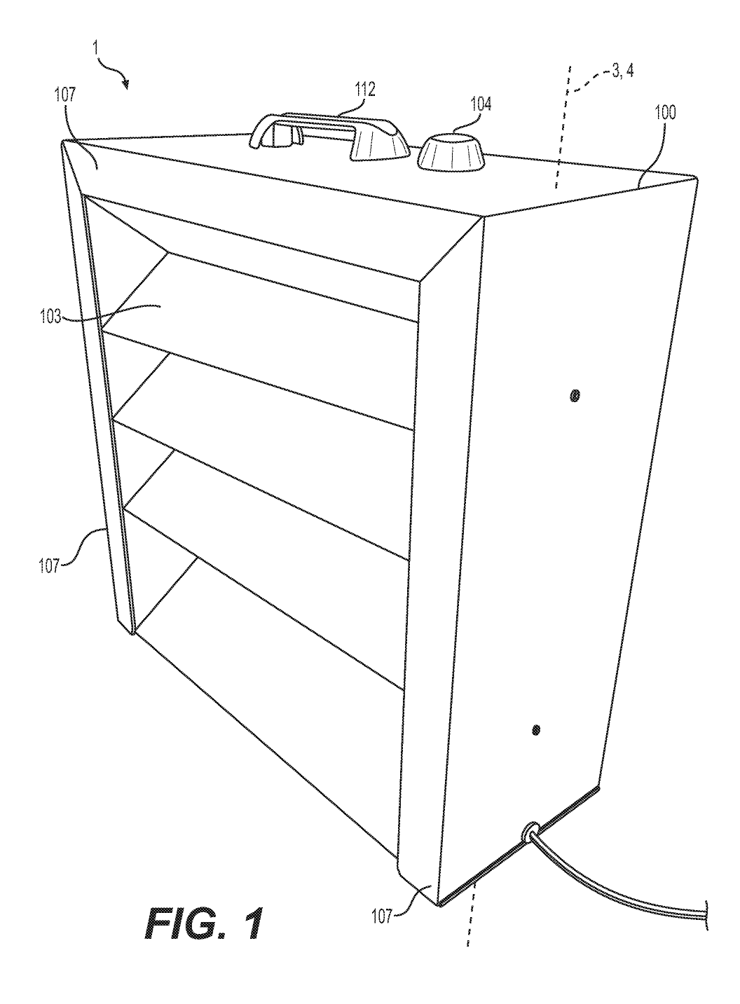

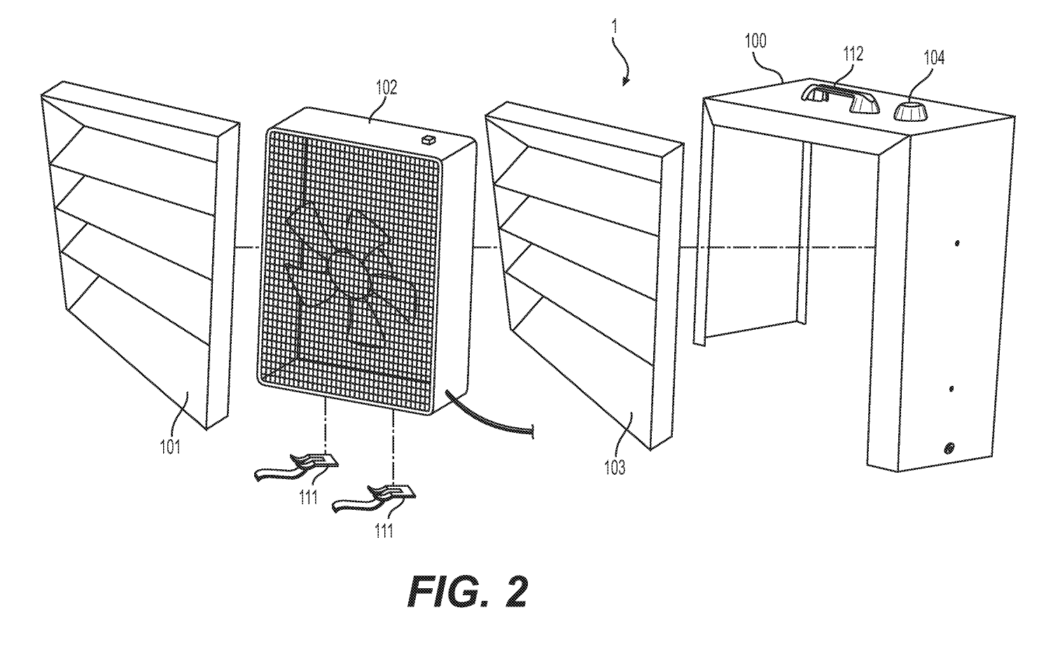

In the illustrated embodiment in FIGS. 1-2, an air filtration and purification unit 1 is shown. The air filtration and purification unit 1 has a shroud or housing 100, a pre-filter 101, a box fan assembly 102, and a post-filter 103. The pre-filter and post filters 101, 103 sandwich the fan assembly 102, and are held in place by clips, clamps, or crimping 111. In the illustrated embodiment, filters 101, 103 are identical.

The shroud 100 surrounds the pre-filter 101, the fan assembly 102, and the post-filter 103 on at least three sides and further includes lips 107 on all three sides which act as stops so the filter does not fall out of place. At least one side may be open to allow for easy replacement of filters 101, 103. The shroud 100 may be made from metals such as stainless steel, galvanized steel, aluminum, plastics, such as polycarbonate, or any appropriate materials known in the art, whether now known or later developed. On the exterior of the shroud 100, located on top of the unit is a fan speed selection switch 104 which may have high, medium, low, and off positions. Also on top of the shroud 100 is a handle 112 for easy movement and portability of the air purification and filtration system. It is understood that the thickness of the filters will alter the dimensions of the shroud 100 and does not limit the invention, i.e. 20×20×2 inch filters, 20×20×4 inch filters. It is understood that an X-pattern grid filter holder may also be used herein with the invention.

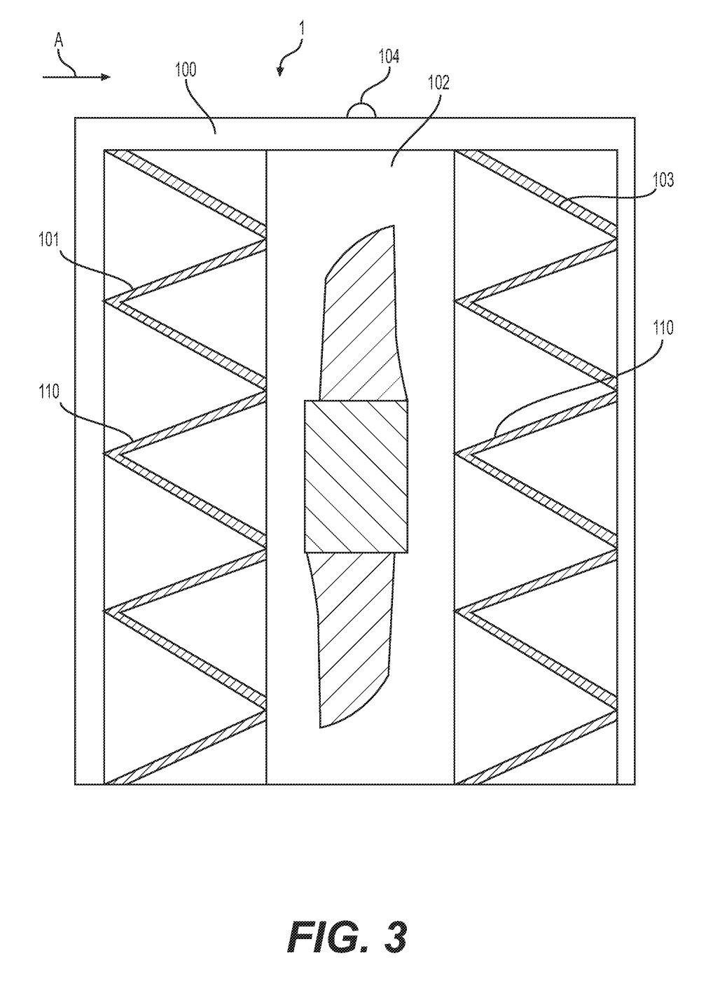

FIG. 3 shows a cross-sectional view of an air filtration and purification unit 1. Air will flow in direction A. The filters 101, 103 may be made from fibrous material, paper, or other known or yet to be known materials in the art. The filters 101, 103 are pleated with individual pleats 110. These pleats 110 are folded such that they create a 45 degree isosceles triangular pattern in a uniform pattern. A standard efficient filter is made from a MERV rated material as is known in the art, and then is folded a pre-set number of times (creating pleats) for a given standard dimension, thereby having a set surface area and length of material used that is known in the art that will create a MERV rated filter. The pleated design of the filters 101, 103 have less pleats 110 than a standard efficient filter and therein use less surface area, but still are efficient to be rated to a Minimum Efficiency Reporting Value (MERV) rating of 11 or better, which goes against the logic that the more pleats (or surface area) the better the filtration of the created filter.

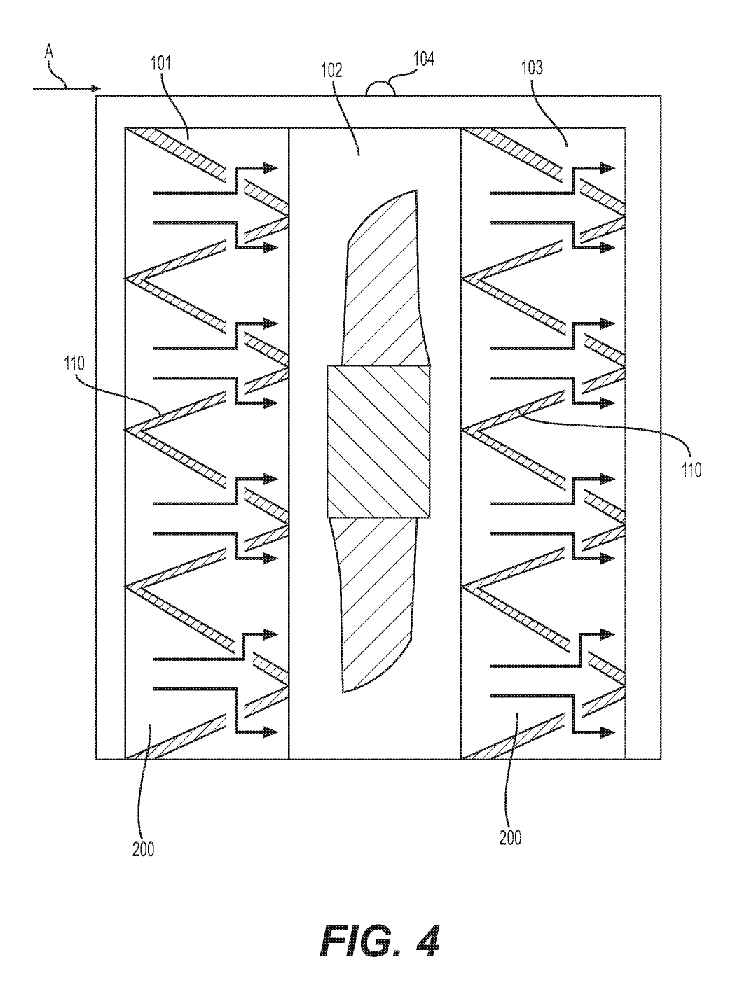

FIG. 4 shows the flow of air 200 through the air filtration and purification unit 1. The air flows through the pre-filter 101, then through the fan assembly 102, and thereafter through the post filter 103. By placing the pleats 110 at angles with respect to one another, the air flow 200 splits to create a Venturi effect at this first constriction. The fan assembly 102 controls the speed of the air flow 200, and at slower fan blade speeds, the filters 101, 103 can clean without harming the filters 101, 103. The filters 101,103 are placed at opposite ends of the fan assembly 102. The split air flow 200 has the added advantage of reducing the noise of the air flow 200 through the filtration and purification system. In the addition, the filters 101,103 may by pleated in a variety of ways and will be further discussed below, and the number of pleats may be varied to slow the air flow 200.

By using the post filter 103 after the air passes through the fan 102, the air is defused and again goes through a Venturi effect as it passes through the post filter 103, which cleans as much as 40% more than using the pre-filter 101 only. As a result, the filters 101, 103 last much longer and clean better.

Current air handling and heating, ventilation, and air conditioning (HVAC) systems are designed for high air speed and air volume (i.e between 2.5 m/s to 30 m/s dependent upon the size of the system). The use of the pre-filter 101 and the post-filter 103 in such HVAC systems would create too much drag or resistance to the air flow, and such systems would not operate correctly. Accordingly, the fan assembly 102 should be selected so that it has a lower, slower air speed and volume (e.g., 0.2 m/s to 0.666 m/s), which allows the system to clean the air more thoroughly and more efficiently, and preserves and prolongs the life of the filters 101, 103. Slower air speed/volume fans are also generally less expensive and quieter, so their use in this application may well impart an economic advantage to this air filtration and purification system, as well as a quieter, more pleasant environment. Moreover, slower speed fans 102 are typically smaller and weigh less than high speed, high volume fans, making the portable air filtration and purification system easier to move and position. Indeed, testing has shown that use of the fan 102 to cause the air to slow down and circulate within the unit 1 allows for more particulates in the air to be captured, such that the air 200 ultimately exiting the post-filter 103 is substantially cleaner as compared to the air exiting prior art filtration systems.

It is foreseen that the filters 101, 103 may be replaced with standard high efficiency pleated filters with a MERV rating of 8 or better as known in the art and this would be within the scope of the invention. It is also foreseen that they may be any combination of the filters disclosed herein and standard high efficiency pleated filters may be used.

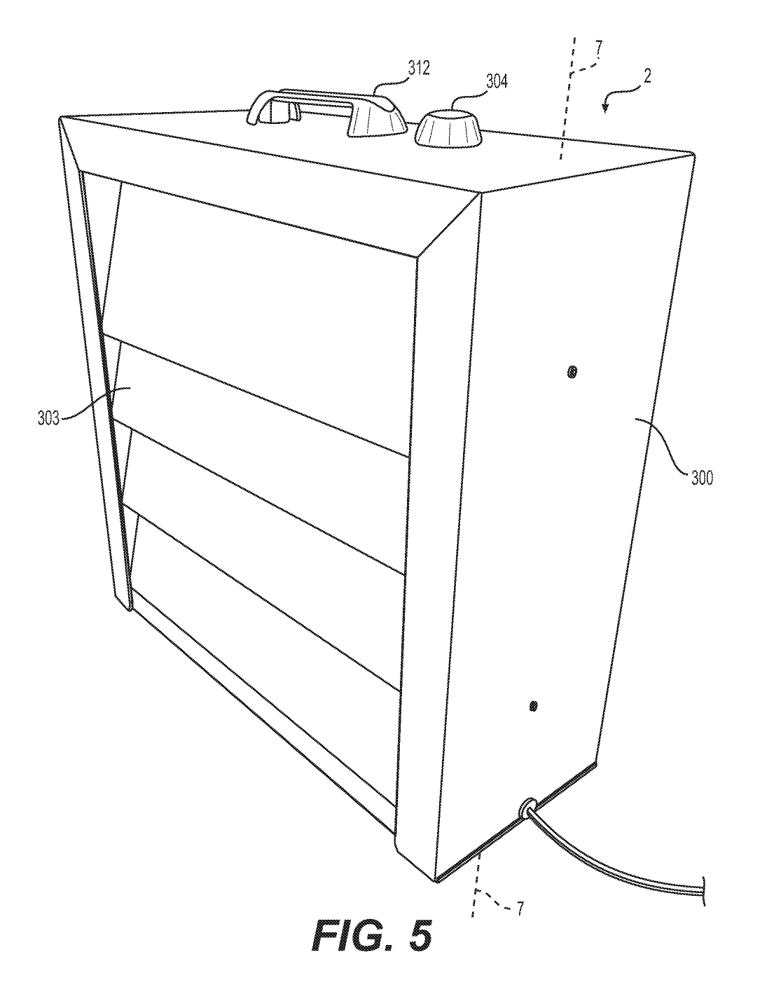

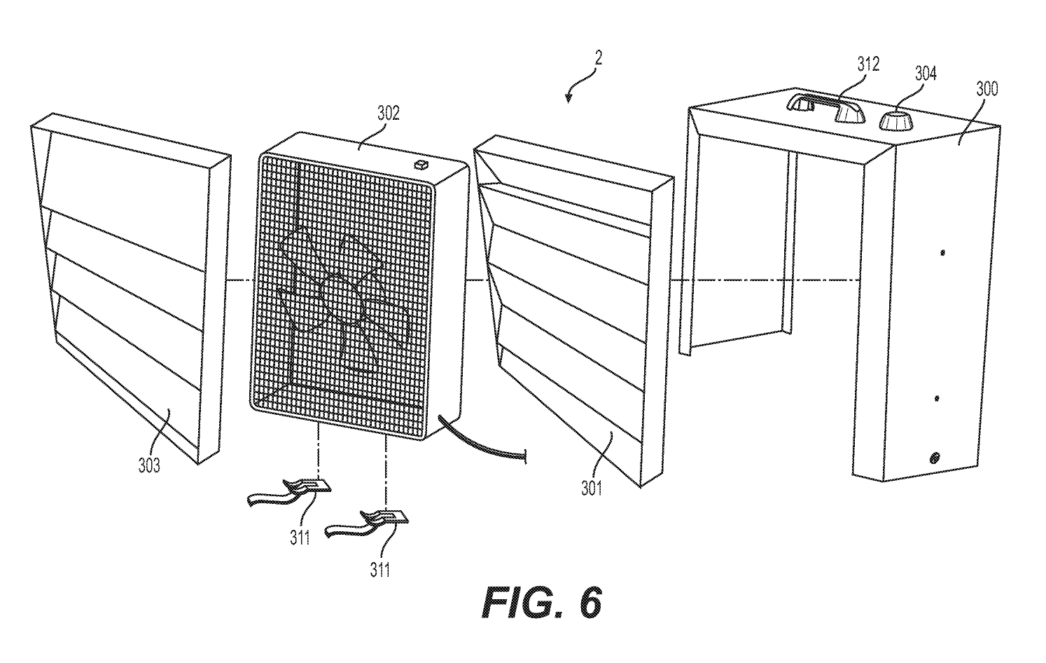

In the illustrated embodiment in FIGS. 5-7, an air filtration and purification unit 2 is shown. The air filtration and purification unit 2 has a shroud or housing 300, a pre-filter 301, a box fan assembly 302, and a post-filter 303. The air filtration and purification unit 2 is substantially similar to the air filtration and purification unit 1, with the exception of the filters 301, 303 utilized in the embodiment. The pre-filter and post filters 301, 303 sandwich the fan assembly 302.

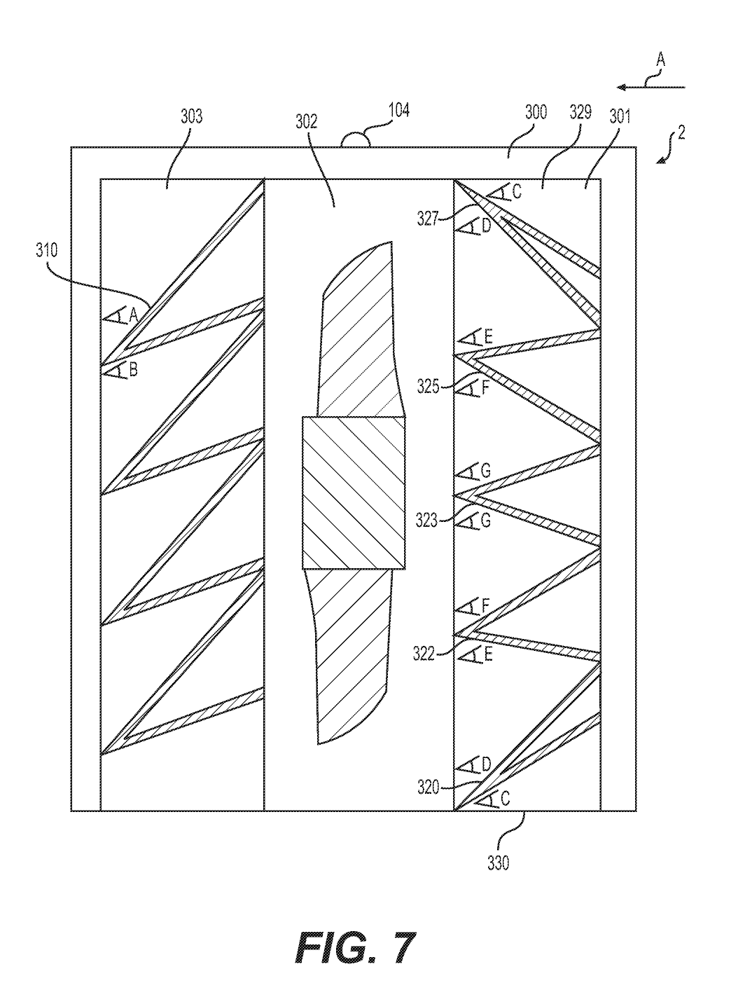

The pre-filter 301 may be made from fibrous material, paper, or other known or yet to be known materials in the art. The pre-filter 301 may be dimensioned to be 20×30×2 inches or a standard filter size known in the art. The pre-filter 301 has five individual pleats 320, 322, 323, 325, 327 (FIG. 7) with the pleats facing towards the fan in the direction of the air A. The outer pleats 320, 327 are angled from a top 329 to a bottom 330 of the shroud 300 at an angle C with respect to the horizontal between 50 and 60 degrees, preferably at 55 degrees and then folded back at an angle D with respect to the horizontal between 55 and 65 degrees, preferably at 59.7 degrees. The inner pleats 322, 325 adjacent the outer pleats 320, 327 are angled from the outer pleats 320, 327 at an angle E with respect to the horizontal between 35 to 45 degrees, preferably at 40.6 degrees and then folded back at an angle F with respect to the horizontal between 45 and 55 degrees, preferably at 48.8 degrees. The center pleat 323 is angled from the inner pleats 322, 325 at an angle G with respect to the horizontal between 25 and 30 degrees, preferably at 28.6 degrees. The non-uniform folding pleated design of the pre-filter 301 and post-filter 303 in unison outperform current known in the art standard uniform pleating designs having multitudes of pleats in the same dimension. The pleated design of the pre-filter 301 filters uses less material (in comparison to a same dimensioned standard pleated filter) due to the nature of the curves and also filters in the 0.3 μm range to be rated to a MERV rating of 11 or better. The pre filter 301 is better rated than currently known in the art standard pleated using material with a MERV rating of 13-15 that have more uniform horizontal pleats or folds (not shown) and use a greater surface area having the same dimensions, i.e. 20×20×2 inches.

It is foreseen that the pre-filter 301 may be utilized to test different filtrations efficiencies by observing the filtration efficiency of a single pleat design at the above noted angle ranges through the air filtration and purification unit 2. This efficiency can then be compared to a standard pleated filter having the same dimensional size. It is foreseen that the pre-filter 301 may be oriented on either side of the fan or utilized as both the pre-filter 301 and the post-filter 303.

The post-filter 303, likewise may be made from fibrous material, paper, or other known or yet to be known materials in the art. The post-filter 303 may be dimensioned to be 20×20×2 inches or any standard filter size known in the art. The post-filter 303 has several individual pleats 310 pointed in the direction of the airflow A, and each pleat 310 is angled downwardly with respect to a horizontal, at an angle A between 25 to 35 degrees (FIG. 7) preferably at 29.7 degrees and then folded over itself at an angle B between 10 to 20 degrees with respect to the horizontal, preferably at 14.2 degrees. The pleated design of the post-filter 303 filters uses less material and therefore less surface area (in comparison to a same dimensioned standard pleated filter) due to the natural of the downward curves and also filters in the 0.3 μm range to be rated to a MERV rating of 11 or better. The post filter 303 is better rated than currently known in the art standard pleated filters using materials with a MERV rating of 13-15 that have more uniform horizontal pleats (not shown) and use a greater surface area. The non-uniform angular design may not be made using standard pleating machinery. The post-filter 303 may be oriented on either side of the fan or utilized as both the pre-filter 301 and the post-filter 303.

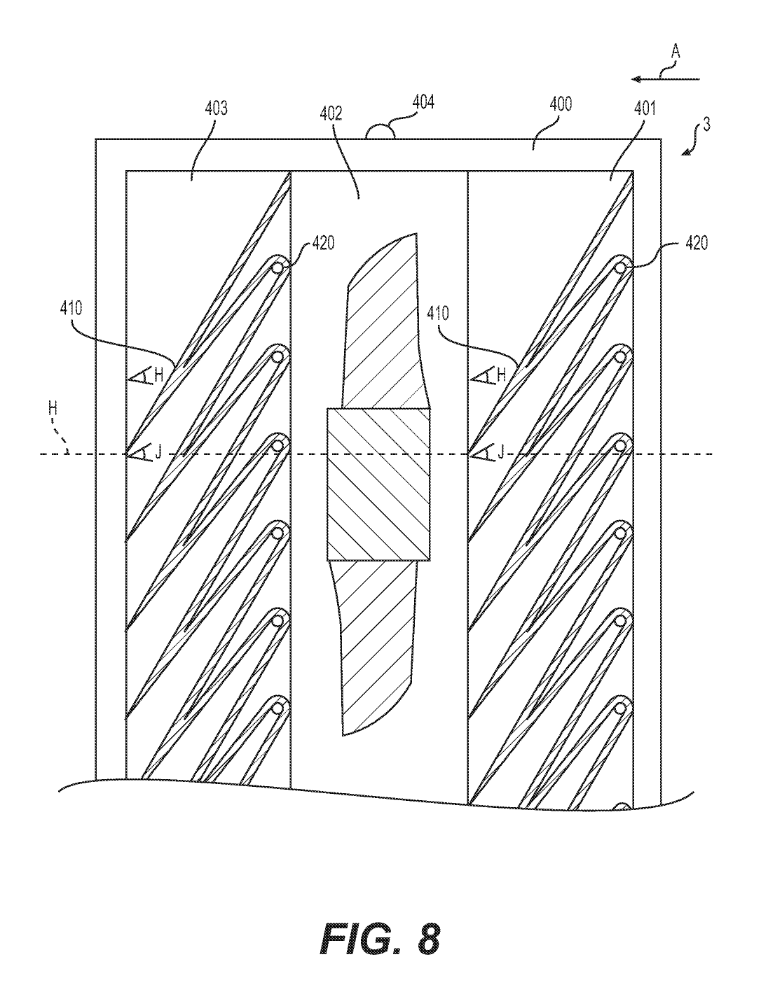

FIG. 8 shows a cross-sectional view of another embodiment of an air filtration and purification unit 3. The filters 401, 403 may be made from fibrous material, paper, or other known or yet to be known materials in the art. The filters 401, 403 may be dimensioned to be 20×20×2 inches or a standard filter size known in the art. The pre-filter 401 and the post filter 403 are identical in the illustrated embodiment. The filters 401, 403 have several individual pleats 410 oriented in the direction of air A, and each pleat 410 is angled downwardly with respect to a horizontal H, at an angle H between 55 to 65 degrees, preferably at 60 degrees and then folded over itself at an angle J between 50 to 55 degrees with respect to the horizontal H, preferably at 52 degrees. From there the material is wrapped about rod or conduit 420 that is held in place by a bearing (not shown).

The pleated design of the filters 401, 403 were tested at several downwardly sloping angles that approached 90 degrees or vertical (which will not allow any air through), and these angles H, J were determined to filter out the most microbial particles at the 0.3 μm range, thereby making a MERV 15 though utilizing material with MERV rating of 11. One result of such a test given by Assuredbio is given below.

TABLE 1
Test Results for Standard Filter MERV rating 11

| Species indentification | Spore/m³ of Air Inside | Spore/m³ of Air Outside | (%) of Detected Species |
|---|---|---|---|
| Acremonium strictum | ND | ND | 0.00 |
| Alternaria alternata | 2,065 | 2,503 | 12.52 |
| Aspergillus niger/awamori/foetidus/phoenicis | ND | ND | 0.00 |
| Aspergillus flavus/oryzae | ND | ND | 0.00 |
| Aspergillus fumigatus, Neosartorya fischeri | ND | 3,517 | 0.00 |
| Aspergillus ochraceus/ostianus | ND | ND | 0.00 |
| Aspergillus penicillioides | ND | ND | 0.00 |
| Aspergillus restrictus/caesillus/conicus | 51 | 51 | 0.31 |
| Aspergillus sclerotiorum | ND | ND | 0.00 |
| Aspergillus sydowii | ND | ND | 0.00 |
| Aspergillus unguis | ND | ND | 0.00 |
| Aspergillus ustus | ND | ND | 0.00 |
| Aspergillus versicolor | ND | ND | 0.00 |
| Aureobasidium pullulans | ND | 183 | 0.00 |
| Chaetomium globosum | ND | ND | 0.00 |
| Cladosporium cladosporioides svar. 1 | 85 | 40 | 0.52 |
| Cladosporium cladosporioides svar. 2 | ND | ND | 0.00 |
| Cladosporium herbarum | 13,759 | 8,342 | 83.42 |
| Cladosporium sphaerosperrnum | 157 | ND | 0.95 |
| Eurotium (Aspergillus) amstelodami/ | ND | ND | 0.00 |
| chevalleri/herbariorum/rubrum/repens | | | |
| Epicoccum nigrum | ND | ND | 50.00 |
| Mucor amphibiorum/circinelloides/hiematis/ | ND | ND | 0.00 |
| indicus/mucedo/racemosus/ramoissimus and | | | |
| Rhizopus azygosporus/homothalicus/ | | | |
| microsporus/oligoporus/oryzae | | | |
| Paecilomyces variotii | ND | ND | 0.00 |
| Penicillium crustosum/camemberti/commune/ | ND | ND | 0.00 |
| echinulatum/solitum | | | |
| Penicillium brevicompactum \| stoloniferum | ND | ND | 0.00 |
| Penicillium chrysogenum | ND | ND | 0.00 |
| Penicillium corylophilum | ND | ND | 0.00 |
| Penicillium purpurogenum | ND | ND | 0.00 |
| Penicillium variabile | ND | ND | 0.00 |
| Penicillium glabrum/lividum/purpurescens/ | ND | ND | 0.00 |
| spinulosum/thomii | | | |
| Rhizopus stolonifer | ND | ND | 0.00 |
| Scopulariopsis brevicaulis \| fusca | 216 | 198 | 1.31 |
| Scopulariopsis chartarum | 7 | 7 | 0.04 |
| Stachybotrys chartarum | 153 | ND | 0.93 |
| Trichoderma viride/atroviride/koningii | ND | ND | 0.00 |
| Wallemia sebi | ND | 154 | 0.00 |
| Total Spores | 16,493 | 14,841 | |

TABLE 2
Test Results for Filter 401/403

| Species indentification | Spore/m³ of Air Inside | Spore/m³ of Air Outside | (%) of Detected Species |
|---|---|---|---|
| Acremonium strictum | ND | ND | 0.00 |
| Alternaria alternata | ND | ND | 0.00 |
| Aspergillus niger/awamori/foetidus/phoenicis | ND | ND | 0.00 |
| Aspergillus flavus/oryzae | ND | ND | 0.00 |
| Aspergillus fumigatus, Neosartorya fischeri | ND | ND | 0.00 |
| Aspergillus ochraceus/ostianus | ND | ND | 0.00 |
| Aspergillus penicillioides | ND | ND | 0.00 |
| Aspergillus restrictus/caesillus/conicus | ND | ND | 0.00 |
| Aspergillus sclerotiorum | ND | ND | 0.00 |
| Aspergillus sydowii | ND | ND | 0.00 |
| Aspergillus unguis | ND | ND | 0.00 |
| Aspergillus ustus | ND | ND | 0.00 |
| Aspergillus versicolor | ND | ND | 0.00 |
| Aureobasidium pullulans | ND | ND | 0.00 |
| Chaetomium globosum | ND | ND | 0.00 |
| Cladosporium cladosporioides svar. 1 | 7 | 9 | 50.00 |
| Cladosporium cladosporioides svar. 2 | ND | ND | 0.00 |
| Cladosporium herbarum | ND | ND | 0.00 |
| Cladosporium sphaerosperrnum | ND | ND | 0.00 |
| Eurotium (Aspergillus) amstelodami/ | ND | ND | 0.00 |
| chevalleri/herbariorum/rubrum/repens | ND | ND | 0.00 |
| Epicoccum nigrum | 7 | ND | 50.00 |
| Mucor amphibiorum/circinelloides/hiematis/ | ND | ND | 0.00 |
| indicus/mucedo/racemosus/ramoissimus and | | | |
| Rhizopus azygosporus/homothalicus/ | | | |
| microsporus/oligoporus/oryzae | | | |
| Paecilomyces variotii | ND | ND | 0.00 |
| Penicillium crustosum/camemberti/commune/ | ND | ND | 0.00 |
| echinulatum/solitum | | | |
| Penicillium brevicompactum \| stoloniferum | ND | ND | 0.00 |
| Penicillium chrysogenum | ND | ND | 0.00 |
| Penicillium corylophilum | ND | ND | 0.00 |
| Penicillium purpurogenum | ND | ND | 0.00 |
| Penicillium variabile | ND | ND | 0.00 |
| Penicillium glabrum/lividum/purpurescens/ | ND | ND | 0.00 |
| spinulosum/thomii | | | |
| Rhizopus stolonifer | ND | ND | 0.00 |
| Scopulariopsis brevicaulis \| fusca | ND | ND | 0.00 |
| Scopulariopsis chartarum | ND | ND | 0.00 |
| Stachybotrys chartarum | ND | ND | 0.00 |
| Trichoderma viride/atroviride/koningii | ND | ND | 0.00 |
| Wallemia sebi | ND | 154 | 0.00 |
| Total Spores | 13 | 164 | |

The standard filter with a MERV rating of 11, there were 16,493 spores/m³ detected inside and 14,841 spores/m³ detected outside, whereas with the non-uniform angled downward pleat design filters 401, 403, 13 spores spores/m³ were detected inside and 164 spores/m³ were detected outside. The results being a magnitude difference between the two filters tested, each being the same dimension and using the same MERV 11 rated material.

The filters 401, 403 use less material (in comparison to a same dimensioned standard pleated filter) due to the natural of the downward curves and also filter in the 0.3 μm range. In a 20×20×2 inch filter size, 92 inches of material is used for a conventional known in the art pleated filter and in the filters 401, 403 at those dimensions, 82 inches of material is utilized. The filter 401, 403 is better rated than currently known in the art standard pleated designs made of the same material that have more uniform horizontal pleats (not shown) and use a greater surface area. It is foreseen that the air filtration and purification system 3 may be utilize any versions of filters previously discussed or a standard conventional filter.

The portable air filtration and purification system disclosed herein may be used in areas where it is most needed or desired. It thoroughly cleans the air in the area in which it is placed, is easy to move, economical, is quiet, and prolongs the life of the filters. It may also be used with or in addition to current HVAC systems wherein each filter may be placed at beginning and ends of ventilation systems. It is also understood that the filters discussed herein may be utilized outside the air filtration and purification unit, in the realms of automotive engines, includes cars, boats, aircraft, as well as ventilation systems and human made environments (satellites, space shuttles, etc.).

Thus, the present inventions have been described in detail with the understanding that the present detailed description is subject to modification and alterations without departing from the teaching herein. Therefore, the present invention should not be limited to the precise details presented herein but should encompass the subject matter of the claims and their equivalents, which follow.

1. A portable air filtration and purification system comprising:
a portable housing having three sides and an open area, the open area configured to facilitate filter replacement;
a pre-filter positioned within the housing;
a fan assembly having a fan housing and fan blades, the fan assembly positioned within the housing and being adjacent the pre-filter; and
a post-filter adjacent the fan assembly and positioned within the housing such that the pre-filer and the post-filter sandwich the fan assembly;
wherein:
the pre-filter intercepts the air flow into the portable air filtration and purification system before the air flows through the fan, and
the post-filter intercepts the air after it flows through the fan.

2. The system of claim 1, wherein the filters are pleated filters with a Minimum Efficiency Reporting Value (MERV) rating of 8 or better.

3. The system of claim 1, wherein the pre-filter has at least two pleats, the at least two pleats being positioned 45 degree angles apart from one another.

4. The system of claim 1, wherein the post-filter has at least two pleats, the at least two pleats being positioned 45 degree angles apart from one another.

5. The system of claim 3, wherein the at least two pleats are positioned at unequal angles with respect to one another.

6. The system of claim 4, wherein the pre-filters are positioned at unequal angles with respect to one another.

7. The system of claim 1, wherein the fan assembly rotates the fan blades at a speed between 0.2 m/s to 0.666 m/s.

8. The system of claim 7, further comprising a switch that sets the rotation of the fan blades.

9. The system of claim 1, wherein the pre-filter has at least two pleats, the at least two pleats each have an initial angle angled downwardly between 25 to 35 degrees and then folded over itself at a second angle between 10 to 20 degrees.

10. The system of claim 1, wherein the pre-filter has at least two pleats, the at least two pleats each have an initial angle angled downward between 55 to 65 degrees and then folded over itself at a second angle between 50 to 55 degrees.

11. The system of claim 1, wherein the post-filter has at least two pleats, wherein the at least two pleats each have an initial angle between 25 to 35 degrees and then folded over itself at a second angle between 10 to 20 degrees.

12. The system of claim 1, wherein the post-filter has at least two pleats, the at least two pleats each have an initial angle angled downward between 55 to 65 degrees and then folded over itself at a second angle between 50 to 55 degrees.

13. The system of claim 1, wherein the pre-filter includes a central pleat, an inner pleat, and an outer pleat, wherein the outer pleat has a first angle between 55 and 65 degrees and then folded back at a second angle between 50 and 60 degrees, the inner pleat being adjacent the outer pleats has a third angle between 35 to 45 degrees and then folded back at a fourth angle between 45 and 55 degrees, and the center pleat is angled from the inner pleat at an angle between 25 and 30 degrees.

14. The system of claim 1, wherein the post-filter includes a central pleat, an inner pleat, and an outer pleat, wherein the outer pleat has a first angle between 55 and 65 degrees and then folded back at a second angle between 50 and 60 degrees, the inner pleat being adjacent the outer pleats has a third angle between 35 to 45 degrees and then folded back at a fourth angle between 45 and 55 degrees, and the center pleat is angled from the inner pleat at an angle between 25 and 30 degrees.

15. The system of claim 1, wherein the pre-filter and the post-filter are identical.

16. The system of claim 1, wherein the pre-filter has at least two pleats, each pleat being adjacent a rod.

17. The system of claim 1, wherein the post-filter has at least two pleats, each pleat being adjacent a rod.

18. A portable air filtration and purification system comprising:
a first filter having at least two pleats, the at least two pleats each have an initial angle angled downward between 55 to 65 degrees and then folded over itself at a second angle between 50 to 55 degrees;
a fan; and
a second filter adjacent the fan;
wherein, the first filter and the second filter sandwich the fan.

19. A portable air filtration and purification system comprising:
a portable housing;
a pre-filter positioned within the housing and having a first set of pleats;
a fan assembly having a fan housing and fan blades, the fan assembly positioned within the housing and being adjacent the pre-filter; and
a post-filter adjacent the fan assembly and positioned within the housing such that the pre-filer and the post-filter sandwich the fan assembly, the post-filter having a second set of pleats;
wherein:
the pre-filter intercepts the air flow into the portable air filtration and purification system before the air flows through the fan, and
the post-filter intercepts the air after it flows through the fan;
wherein, in an operating position, the pre-filter and the post filter is each positioned within the housing such that an outermost portion of a plurality of pleats within the first set of pleats and the second set of pleats faces a surface on which the portable housing is situated.

20. The portable air filtration and purification system of claim 19, wherein said surface is parallel to the ground.
